(19) United States
(12) Patent Application Publication
(10) Pub. No.: US 2007/0151160 A1
(43) Pub. Date: Jul. 5, 2007

(54) Window regulator motor mount

(75) Inventors: Shinsuke Obinata, Hiroshima (JP); Hirotsugu Takai, Kanagawa (JP); Katsutomo Fujii, Hiroshima (JP); Kazuhiro Kochi, Hiroshima (JP)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Japan K.K.

(21) Appl. No.: 11/321,913

(22) Filed: Dec. 29, 2005

(51) Int. Cl. E05F 11/48

(52) U.S. Cl. 49/352

(57) ABSTRACT

A window regulator assembly for a vehicle door includes a front rail, a rear rail, and a motor that is used to control movement of a window panel relative to the front and rear rails. The motor is mounted to an upper rail end of one of the front and rear rails. This frees up a significant amount of packaging space within the vehicle door. Further, the window regulator assembly can be easily installed within the vehicle door by vertically inserting the window regulator assembly as a complete unit into the vehicle door.

### TECHNICAL FIELD

The subject invention relates to window regulator assembly for a vehicle door that includes a motor mounted to a top portion of a lift.

### BACKGROUND OF THE INVENTION

A window regulator assembly includes front and rear rails that are mounted within a vehicle door. A motor and associated drive elements are used to control movement of a window relative to the front and rear rails within the vehicle door. The motor drives the window back and forth along the front and rear rails to move the window between open and closed positions.

Currently, the motor is supported by a center portion of the front rail. A bracket is used to mount the motor to this center portion. The bracket extends rearwardly from the front rail toward the rear rail, positioning the motor generally in a center space between the front and rear rails. This mounting configuration thus takes up a significant amount of available space between the front and rear rails, leaving little room for other door system components or inner trim panel design possibilities.

Another disadvantage with current window regulator assemblies is that assembly can be difficult and time consuming. A work hole is formed within one side of a door panel. The window regulator assembly is inserted sideways and upwardly on an angle into the work hole to position the window regulator assembly in the vehicle door. Such an assembly process is awkward for workers.

Thus, there is a need to provide a window regulator assembly that takes up less space in an area between the front and rear rails, and which is easier to install.

### SUMMARY OF THE INVENTION

A window regulator assembly is mounted within a vehicle door. The window regulator assembly includes first and second rails that are longitudinally spaced apart from each other within the vehicle door. Each of the first and second rails includes an upper rail end and a lower rail end. The window regulator assembly includes a motor that is mounted to an upper rail end of one of the first and second rails. This configuration significantly increases the amount of available space within the vehicle door for other door system components.

The subject window regulator is also easily installed into the vehicle door as a complete unit. The vehicle door includes an upper door edge that extends in a longitudinal direction. The window regulator assembly, i.e. the first and second rails, motor, and other associated drive elements, is inserted downwardly into the vehicle door from the upper door edge. Thus, the window regulator assembly is easily installed in one easy insertion step by moving the complete unit vertically along a generally linear path into the vehicle door.

These and other features of the present invention can be best understood from the following specification and drawings, the following of which is a brief description.

### BRIEF DESCRIPTION OF THE DRAWINGS

FIG. 1 is a schematic view of a vehicle door with a window regulator assembly incorporating the subject invention.

FIG. 2 is a perspective view of the window regulator assembly showing prior and current motor mounting positions.

FIG. 3 is a schematic view showing the window regulator assembly of FIG. 2 being installed within a vehicle door.

### DETAILED DESCRIPTION OF THE PREFERRED EMBODIMENT

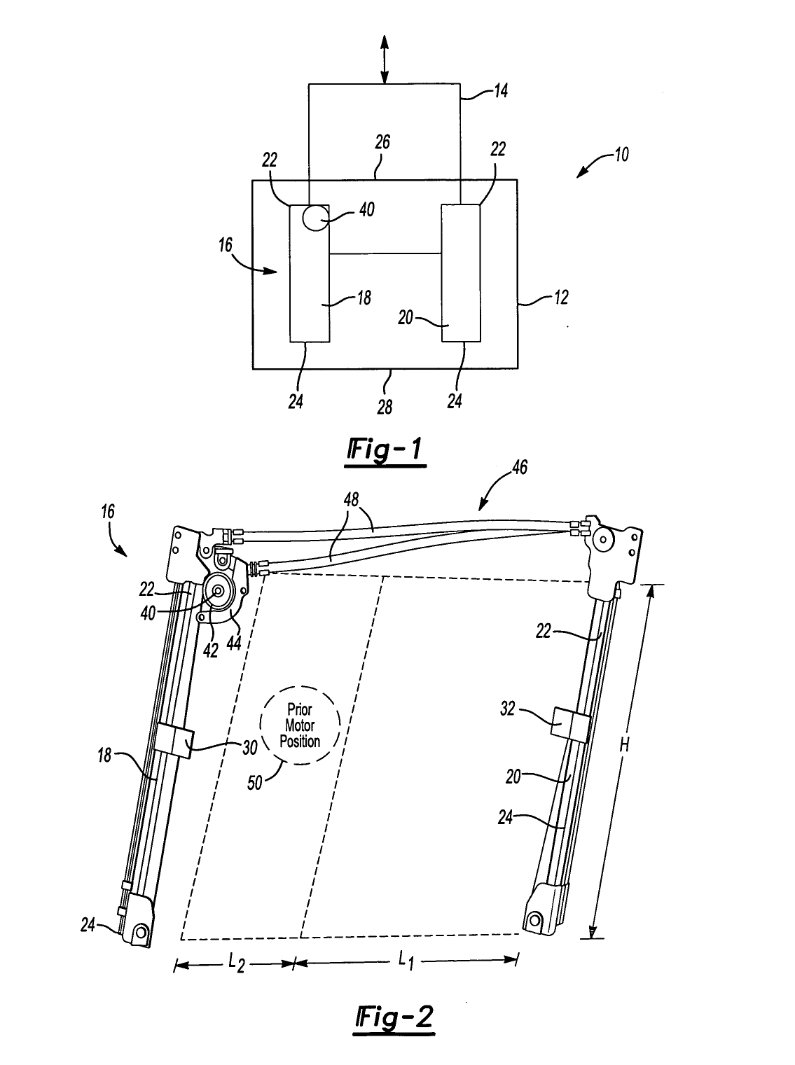

As shown in FIG. 1, a vehicle door 10 includes a door panel 12 and a window 14 that moves relative to the door panel 12 between open and closed positions. A window regulator assembly 16 is mounted within the vehicle door 10 to control movement of the window 14.

The window regulator assembly 16 is shown in greater detail in FIG. 2. The window regulator assembly 16 includes a front rail 18 and a rear rail 20. The front 18 and rear 20 rails are longitudinally spaced apart from each other within the vehicle door 10 (FIG. 1).

Each of the front 18 and rear 20 rails includes an upper rail end 22 and a lower rail end 24. The upper rail ends 22 are positioned near an upper edge 26 (FIG. 1) of the vehicle door 10 and the lower rail ends 24 are positioned near a lower edge 28 (FIG. 1) of the vehicle door 10. A front cursor 30 is supported on the front rail 18 and a rear cursor 32 is supported on the rear rail 20. The front 30 and rear 32 cursors support the window 14 for movement up and down the front 18 and rear 20 rails as known.

The window regulator assembly 16 includes a motor 40 that is mounted to an upper rail end 22 of one of the front 18 and rear 20 rails. Preferably, the motor 40 is mounted to the upper rail end 22 of the front rail 18 as shown. The motor 40 includes a housing and panel plate portion 42 that are mounted to bracket 44. The bracket 44 is fixed to the upper rail end 22 of the front rail 18. The motor 40 actuates a drive system 46 to move the front 30 and rear 32 cursors along the front 18 and rear 20 rails. The drive system 46 is preferably a cable drive that includes cables 48 that are coupled to the front 30 and rear 32 cursors.

Traditionally, the motor 40 had been positioned at a location indicated by dashed lines at 50. This traditional configuration left an available space H×L1 for other door system components. The dimension H comprises a height dimension extending generally vertically along a length of the front 18 and rear 20 rails. The L1 dimension comprises a length from a back edge of the motor in the traditional position 50 to the rear rail 20.

In the new mounting configuration, this available space is significantly increased. As shown, this available space is defined by the dimensions H×(L1+L2). The dimension H comprises a height dimension extending generally vertically along a length of the front 18 and rear 20 rails. The L1+L2 dimension comprises a length from a back edge of the motor 40 in the new mounting configuration to the rear rail 20.

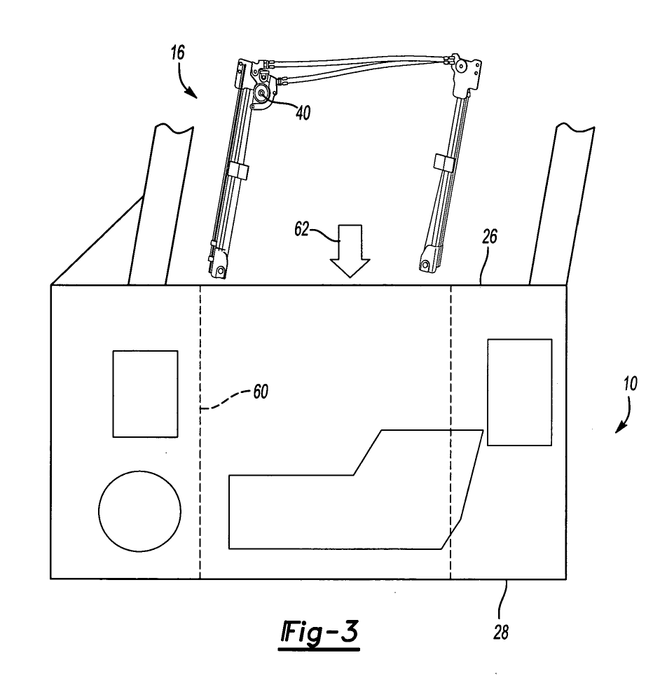

This unique mounting configuration also provides for improved ease of assembly into the vehicle door 10 as shown in FIG. 3. The upper edge 26 of the vehicle door includes an opening or passage 60 that receives the window regulator assembly 16. The window regulator assembly 16 is installed as a complete unit (front and rear rails, motor, etc.) by being inserted downwardly into the passage 60 in a generally vertical direction as indicated by arrow 62. The window regulator assembly 16 is thus easily installed into the vehicle door 10 by being moved along a generally linear downward path in one easy assembly step.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A window regulator comprising:
at least one rail having an upper rail end and a lower rail end; and
a motor mounted to said upper rail end.

2. The window regulator according to claim 1 wherein said motor includes a housing and panel plate that are fixed to said upper rail end.

3. The window regulator according to claim 1 wherein said at least one rail comprises a front rail and a rear rail longitudinally spaced from said front rail and wherein each of said front and said rear rails includes an upper rail end and a lower rail end with said motor being mounted to said upper rail end of said front rail.

4. The window regulator according to claim 1 including window drive elements driven by said motor to move a window relative to said at least one rail wherein said window drive elements are positioned near said upper rail end.

5. The window regulator according to claim 4 wherein said window drive elements comprise cables.

6. The window regulator according to claim 1 wherein said at least one rail is supported within a vehicle door.

7. The window regulator according to claim 6 including a window panel driven by said motor for movement within the vehicle door relative to said at least one rail.

8. A method of assembling a window regulator into a vehicle door comprising the steps of:
(a) providing a vehicle door having an opening for receiving a window regulator assembly; and
(b) inserting the window regulator assembly as a complete unit in a generally vertical direction into the opening.

9. The method according to claim 8 including providing the window regulator assembly with a front rail, a rear rail, and a motor that controls movement of a window panel relative to the front and rear rails.

10. The method according to claim 9 including mounting the motor to an upper rail end of one of the front and rear rails.

11. The method according to claim 10 wherein the opening in the vehicle door is located near an upper door edge and wherein step (b) includes inserting the window regulator through the opening at the upper door edge along a generally linear path extending downward toward ground.
